(19) United States
(12) Patent Application Publication
(10) Pub. No.: US 2024/0131945 A1
(43) Pub. Date: Apr. 25, 2024

(54) IMPROVED SYSTEMS AND METHODS FOR INTEGRATING PV POWER IN ELECTRIC VEHICLES

(71) Applicant: FISKER INC., Manhattan Beach, CA (US)

(72) Inventors: Pranav SANE, Manhattan Beach, CA (US); Ishaan PURANIK, Manhattan Beach, CA (US); Peter WON, Manhattan Beach, CA (US); Ajith WIJENAYAKE, Manhattan Beach, CA (US)

(73) Assignee: FISKER INC., Manhattan Beach, CA (US)

(21) Appl. No.: 18/034,304

(22) PCT Filed: Oct. 26, 2022
(86) PCT No.: PCT/US2022/078828

§ 371 Date: Apr. 26, 2023

Related U.S. Application Data
(60) Provisional application No. 63/263,200, filed on Oct. 28, 2021.

(51) Int. Cl. B60L 53/51; B60L 58/12; H02J 3/00; H02J 3/01; H02J 3/38; H02J 7/00; H02J 7/35

(52) U.S. Cl. CPC B60L 53/51; B60L 58/12; H02J 3/0075; H02J 3/01; H02J 3/38; H02J 7/0048; H02J 7/00712; H02J 7/35; H02J 2300/24; H02J 2310/48

(57) ABSTRACT

An exemplary aspect of this disclosure relates to a charging system comprising a first battery; a photovoltaic array; a battery management system configured to cause a photovoltaic switchgear to open and close, wherein the high voltage switchgear is configured to receive power from the first battery at the same time the first battery receives power from the photovoltaic array through the photovoltaic switchgear; a junction including the photovoltaic switchgear; and a high voltage switchgear, wherein the first battery is configured to receive power from the photovoltaic array when the photovoltaic switchgear is closed.

### CROSS-REFERENCE TO RELATED APPLICATION

This application is a national stage application, filed under 35 U.S.C. 371, of International Patent Application No. PCT/US2022/078828, filed on Oct. 27, 2022, which claims the benefits of priority to U.S. Provisional Patent Application No. 63/263,200, filed on Oct. 28, 2021, the contents of all of which are incorporated herein by reference in their entireties.

### FIELD OF THE DISCLOSURE

The present disclosure relates to methods and systems for charging and operating a high voltage battery system of an electric vehicle.

### BACKGROUND

Photovoltaic systems, including a photovoltaic array, may be installed on a vehicle, for example, on the roof of a vehicle. Photovoltaic systems may supply power to an isolated electrical system associated with the vehicle. Other photovoltaic systems may supply power to a high voltage battery to a vehicle. Yet, the high-energy components used for photovoltaic systems to supply power to the high voltage battery may impose excessive energy drain on the photovoltaic array. This energy drain can be substantial and may reduce or eliminate the ability of the photovoltaic array to provide energy to other electrical systems of the vehicle.

Existing charging systems may include a battery management system that manages and monitors a supply of power of a high voltage battery that receives or sends power through a high voltage switchgear. The high voltage switchgear is typically electrically connected to a high voltage direct current (DC) link that can be activated to allow electric power transfer from the high voltage battery to one or more electric motors. In such systems, the DC link can be de-activated in a sleep or a parked mode of the vehicle. Current vehicles and systems also use electronic control units (ECUs) that draw significant power from available energy sources, such as 12V batteries when the vehicle is in sleep or parked modes. Where a photovoltaic array is used in existing charging systems, the photovoltaic array may provide electrical energy to the high voltage battery through the DC link and through the high voltage switchgear.

A photovoltaic array has relatively low power conversion efficiency and low peak power output. The advantage of the photovoltaic array is to allow the photovoltaic array to produce energy from the sun. When the vehicle is in a parked or off mode for a sufficient period of time, it is desirable to allow the photovoltaic array to provide power to charge a high voltage battery. But, the benefits available from the photovoltaic array are diminished if the system must power a DC link, ECUs, and/or a high voltage switchgear in order for the vehicle to utilize the power from the photovoltaic array, like in prior charging systems. It is thus desirable to provide a system that allows a high voltage battery to be powered from the photovoltaic array without powering the DC link, ECUs, and/or the high voltage switchgear.

It is also desirable to incorporate into a controller a current ramping system and method to efficiently use the electrical energy. It is further desirable to avoid safety concerns of activating the electronic control unit of a vehicle when it is in parked mode. It is further desirable to avoid use of the high voltage switchgear because of a loss of efficiency associated with the large contactors and relays used for the high voltage switchgear.

To achieve these aspects and other advantages according to an embodiment of the present disclosure, the present disclosure relates to methods and system for charging a high voltage battery from a photovoltaic array through a photovoltaic switchgear without the vehicle ECUs, high voltage switchgear, and/or DC link being powered. Additionally, the present disclosure relates to the high voltage switchgear and the photovoltaic switchgear may operate simultaneously. The methods and systems may allow more opportunities for the photovoltaic array to power the high voltage battery.

### SUMMARY

An exemplary aspect of this disclosure relates to a charging system comprising a first battery; a photovoltaic array; a battery management system configured to cause a photovoltaic switchgear to open and close, wherein the high voltage switchgear is configured to receive power from the first battery at the same time the first battery receives power from the photovoltaic array through the photovoltaic switchgear; a junction including the photovoltaic switchgear; and a high voltage switchgear, wherein the first battery is configured to receive power from the photovoltaic array when the photovoltaic switchgear is closed. According to some embodiments, the photovoltaic switchgear may be powered by a second battery. According to some embodiments, the first battery may be configured to power one or more electric motors.

According to some embodiments, the charging system comprises a battery management system that identifies a state of charge of the first battery. If the state of charge of the high voltage battery is less than a threshold, a photovoltaic controller can convert a first voltage produced by the photovoltaic array to a second voltage for the high voltage battery. When the state of charge of the first battery is more than a threshold value, the battery management system is configured to cause a reduction or elimination of power received from the photovoltaic array. According to some embodiments, a photovoltaic integration unit comprises a transformer configured to transfer power from the photovoltaic array to the high voltage switchgear, wherein the photovoltaic integration unit comprises an output diode configured to reduce or eliminate transients or noise in the photovoltaic integration unit from a high voltage connection.

Another exemplary aspect of this disclosure relates to a charging system comprising a high voltage battery; a photovoltaic array; a junction enclosure comprising a high voltage switchgear and a photovoltaic switchgear, wherein the photovoltaic switchgear is configured to receive power from the photovoltaic array, wherein the high voltage battery supplies electrical energy to the electric motor through the high voltage switchgear; a direct current link configured to close when energized; and a battery management system configured to cause the photovoltaic switchgear to open and close; wherein the high voltage battery receives power from the photovoltaic array when the photovoltaic switchgear is closed, wherein the battery receives power from the photovoltaic array when the direct current link is not energized.

Another exemplary aspect of this disclosure relates to a charging system comprising a high voltage battery; a photovoltaic array; a photovoltaic switchgear configured to supply power from the photovoltaic array to the high voltage battery when the high voltage battery receives power from a charger through a high voltage switchgear, and wherein the photovoltaic switchgear is powered by a low voltage battery, and wherein the photovoltaic switchgear is powered by a low voltage battery; a battery management system configured to operate circuitry associated with the battery to allow the battery to receive and provide power, wherein the processor is configured to monitor a state of charge of the high voltage battery; and a photovoltaic integration unit configured to send a signal to the battery management system to enter a wake up mode, wherein in the wake up mode the battery management processor determines whether to receive power from the photovoltaic array based on the state of charge of the battery.

It is to be understood that both the foregoing general description and the following detailed description are exemplary and explanatory only and are not restrictive of the present disclosure. The accompanying drawings, which are incorporated in and constitute a part of this specification, illustrate several exemplary embodiments and together with the description, serve to outline principles of the exemplary embodiments.

### BRIEF DESCRIPTION OF THE DRAWINGS

FIG. 1 is a schematic diagram of an exemplary embodiment of a charging system.

FIG. 2 is a schematic diagram of an exemplary embodiment of a photovoltaic charging operating mode of a charging system.

FIG. 3 is a schematic diagram of an exemplary embodiment of a simultaneous photovoltaic and alternating current charging operating mode of a charging system.

FIG. 4 is a schematic diagram of an exemplary embodiment of a simultaneous photovoltaic and direct current charging operating mode of a charging system.

FIG. 5 is a schematic diagram of an exemplary embodiment of a simultaneous photovoltaic charging and drive operating mode of a charging system.

FIG. 6 is a flow chart depicting an exemplary method of operating a vehicle communication system.

FIG. 7 is a flow chart depicting an exemplary method of operating a power computation circuit within a photovoltaic integration unit.

FIGS. 8A-8C are schematic diagrams of exemplary embodiments of internal architecture of photovoltaic integration units.

FIGS. 9A-9C are flow charts depicting an exemplary method of operating a photovoltaic integration unit and a battery management system.

It is to be understood that both the foregoing general description and the following detailed description are exemplary and explanatory only and are not restrictive of the scope of the present disclosure.

### DETAILED DESCRIPTION

Reference will now be made in detail to exemplary embodiments, some examples of which are shown in the accompanying drawings.

Exemplary disclosed embodiments include apparatus, systems, and methods for a charging system. In an embodiment of the present disclosure, the charging system comprises a photovoltaic array, a photovoltaic converter, a photovoltaic switchgear, a battery management system, and a photovoltaic controller. The photovoltaic array comprises one or more solar cells configured to generate electrical energy from solar energy.

The photovoltaic system can comprise a Photovoltaic Integration Unit (“PVIU”) that converts electrical energy from the photovoltaic array to an electrical output. The PVIU can comprise a direct current-direct current (DC-DC) converter. The PVIU can comprise a transformer. The PVIU can be configured to convert the electrical energy from the photovoltaic array so that the electrical output from the PVIU is constant and/or meets a threshold energy for use in a downstream application.

The photovoltaic switchgear can be configured to control the flow of electrical energy from the PVIU. The photovoltaic switchgear may comprise contactor relays, fuses, and/or switches.

The photovoltaic system can be controlled by the PVIU, which can comprise a controller or a microcontroller. The PVIU can open and close a circuit associated with the photovoltaic array. The photovoltaic controller can receive instructions from a battery management system (BMS). The photovoltaic controller may communicate with the battery management system via a Controller Area Network (CAN).

The electro-mechanical system may be a vehicle. While an electro-mechanical system is in an off mode, it may be charged from the photovoltaic system. The vehicle may be charged from the photovoltaic system when it is in an off mode or a parked mode. The vehicle also may be charged from the photovoltaic system of the present disclosure during a photovoltaic charging mode, an alternating current (“AC”) charging mode, a direct current (“DC”) charging mode, and a drive mode.

To reduce power consumption, the electronic control system can reduce or eliminate the use of power-intensive components such as control units. For a vehicle, the charging system can be configured to reduce or eliminate of the use of ECUs during a photovoltaic charging mode. For example, the ECUs and/or the high voltage switchgear may not be needed for to operate the vehicle during a parked mode or an off mode.

The electro-mechanical system can comprise a DC link that allows the transfer of power to and from the high voltage battery. The photovoltaic charging system can be configured to charge the high voltage battery from the photovoltaic array without energizing the DC link.

In an embodiment of the present disclosure, the high voltage battery may power the electro-mechanical system and a low voltage battery may be configured to provide power to the PVIU. The high voltage battery may be considered a first battery of the vehicle and the low voltage battery may be considered a second battery of the vehicle. The high voltage battery can output a high voltage output at times, and the low voltage battery can output a relatively lower voltage output than the high voltage output possible by the high voltage battery. For example, the high voltage output can provide sufficient power to power one or more electric motors to move a vehicle. As another example, the high voltage output can be around 50V to 2000V. The low voltage battery may be an auxiliary battery. For example, the low voltage battery can provide sufficient power to power an auxiliary system of a vehicle. As another example, the low voltage battery output can be around 9V-15V. The low voltage battery can be a 12V battery.

The charging system can be configured to bypass a high voltage switchgear by actuating independently the photovoltaic PVIU that communicates with the battery management system. The charging system can be configured to allow photovoltaic charging without waking up or operating one or more ECU's and/or energizing the DC link.

The BMS can be configured to control the photovoltaic controller and to communicate with the photovoltaic controller to start and/or stop charging from the photovoltaic array. The photovoltaic controller can be configured to provide information including operating parameters to the BMS for data processing. For example, the photovoltaic controller can provide information to the BMS including current and voltage associated with the photovoltaic array. As another example, the photovoltaic controller can provide information to the BMS including available current and/or voltage. After receiving the information from the photovoltaic controller, the BMS can calculate power and/or accumulated power over time. As another example, the photovoltaic controller can provide information to the BMS including an output current from the PVIU. As another example, the PVIU may provide information to the BMS including the output power from the PVIU and transmit the data over CAN to the BMS periodically.

The BMS may be configured to communicate information to a gateway to upload data (e.g., to a cloud and/or central computing system). The uploaded information can comprise one or more of an instantaneous energy generated by a PV array, an energy of a PV array generated over a period of time (e.g., an hour, a day, a month, a year), and a total amount of energy generated.

In some embodiments, the gateway may be configured to translate one type of CAN (e.g., EV CAN) to another type of CAN (e.g., T CAN). In some embodiments, the gateway can be configured to communicate with a T-box to upload information for later use (e.g., to a cloud and/or a central computing system). The information that is uploaded may be used by a processor (e.g., a UI/UX processor) to compute the miles equivalent generated by the photovoltaic array.

The UI/UX processor can be configured to display information associated with energy generation. The UI/UX processor may be connected to one or more displays of a vehicle.

In some embodiments, an “on” signal can be communicated by the BMS to the PVIU over CAN.

In some embodiments, the VCU can periodically turn on or operate to check parameters of a low voltage battery, such as a 12V battery. In some embodiments, the VCU may determine if the voltage of the low voltage supply is lower than an operational threshold or a predetermined threshold, and if so, the VCU may send a turn on signal to the DC-DC converter to charge the 12V battery from the high voltage battery. This may occur, for example, if the high voltage battery has sufficient state of charge (SOC) to charge the low voltage supply. This process may be used to increase charge of the low voltage supply to continue photovoltaic charging independent of whether the photovoltaic array is charging the high voltage battery.

In some embodiments, the PVIU can monitor the low voltage supply. In some embodiments, the PVIU can determine if the voltage of the low voltage supply is lower than an operational threshold or a predetermined threshold, In some embodiments, the PVIU can determine if the voltage of the low voltage supply is lower than an operational threshold or a predetermined threshold, and if so, the PVIU can discontinue operation to preserve the low voltage supply (e.g., so that a user may still turn on a vehicle).

For safety of operation, the high voltage battery junction box can comprise contactors, relays, and/or fuse, such that a failure or crash may be isolated from the high voltage battery, high voltage switchgear, and/or other power components of the vehicle.

The PVIU can communicate with the BMS over a CAN. The PVIU can be configured to send an operation signal or wake up/power up signal to the BMS when photovoltaic power is available. The BMS may then enter a wake up mode to determine whether the high voltage battery will receive power from the photovoltaic array. This can occur during any operational mode including: a photovoltaic charging mode, an AC charging mode, a DC charging mode, or a drive mode.

The PVIU can comprise a circuit configured to compute the actual as well as expected power produced by the PV array. The PVIU can read a voltage output by the PV array and compute an actual or expected power based on the received voltage and trends in the received voltage and operating conditions. The PVIU can compute the expected power based on data from the time of day and/or one or more sensors that determine if the photovoltaic array is receiving adequate sunlight and how ambient environmental conditions are changing.

The BMS can be configured to allow charging of the high voltage battery through PVIU 104 when the high voltage battery state of charge (SOC) is lower than a threshold of charge. This threshold may be associated with a relatively full charge, a near-full charge, or a predetermined charge. The BMS can be configured to allow charging of the high voltage battery through PVIU 104 when the PVIU output power is greater than the power required by the BMS and the PVIU.

The BMS can be configured to allow charging of the high voltage battery through the PVIU when the high voltage battery is within safe or normal operating limits.

The BMS can be configured to allow charging of the high voltage battery through the PVIU when a low voltage battery system, which may comprise a 12V battery, is within safe or normal operating limits.

The BMS can be configured to send a shut off signal to the PVIU, which may open one or more contactors. The shut off signal may include one or more fault codes. The controller of the PVIU may be configured to send a fault code to the BMS to terminate charging from the photovoltaic array. The BMS may be configured to determine a fault code and/or receive the fault code from the PVIU and may determine to terminate charging when determining and/or receiving one or more fault codes. The BMS may terminate charging by sending a shut down signal to PVIU.

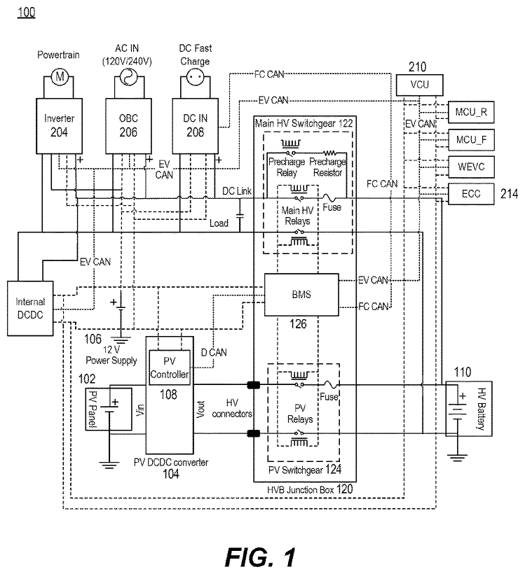

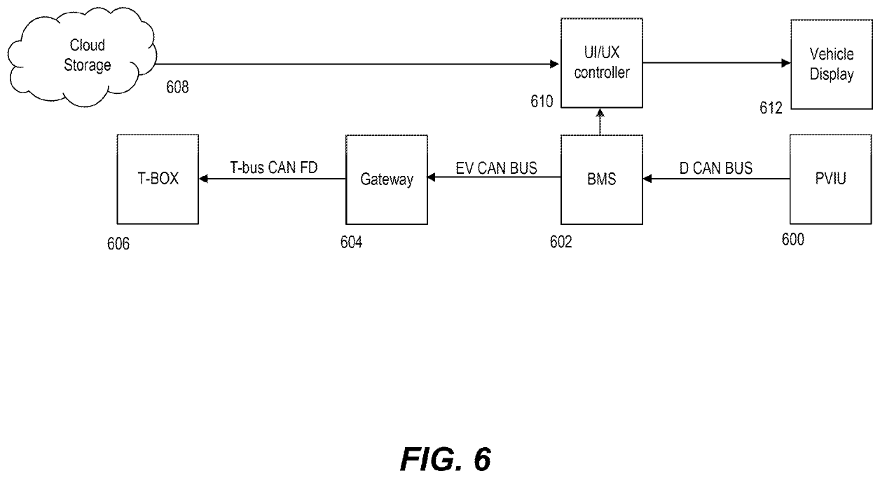

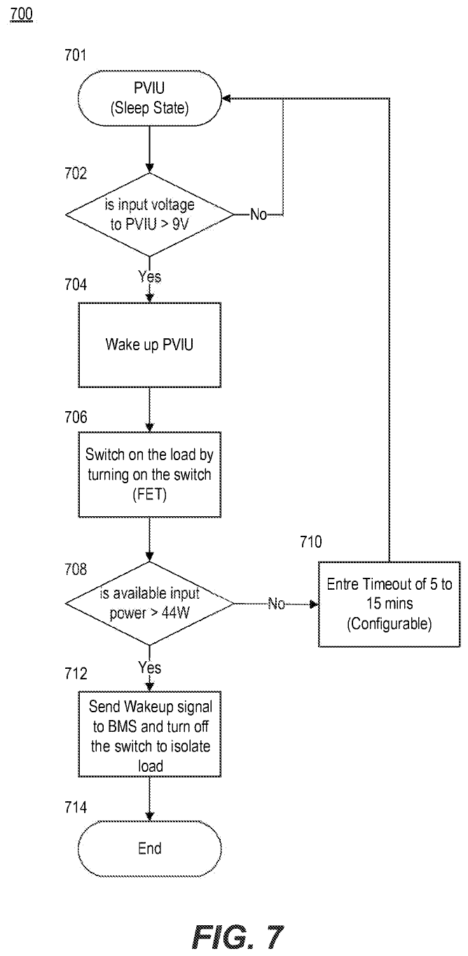

FIGS. 1-5 illustrate non-limiting examples of a battery management system consistent with the present disclosure. FIG. 6 illustrates a non-limiting example of a charging method. FIG. 7 illustrate a non-limiting example of a converter. It is understood that the examples and embodiments described represent simplified descriptions used to facilitate understanding of the principles and methods of this disclosure.

FIG. 1 is a schematic diagram of an exemplary embodiment of charging system 100. Charging system 100 comprises photovoltaic (PV) array 102, high voltage battery junction 120, and high voltage battery 110, and load 112. PV array 102 can comprise a PV panel. PV array 102 can comprise a PV cell. High voltage battery junction 120 comprises one or more of high voltage switchgear 122, PV switchgear 124, and/or BMS 126. High voltage battery 110 comprises one or more batteries capable of providing power to load 112. Load 112 comprises one or more electrical systems or a low voltage battery. One of the one or more electrical systems may comprise an electric motor.

Charging system 100 can further comprise PVIU 104. PVIU 104 may comprise PV controller 108. PVIU 104 may be powered by an auxiliary power supply separate from a vehicle low voltage system. The auxiliary power supply may receive power from low voltage battery 106 and/or may receive power from photovoltaic array 102. In some embodiments, PV controller 108 may be powered by the vehicle low voltage system (e.g., if PVIU 104 does not include an auxiliary power supply). In some embodiments, the low voltage battery 106 and/or the vehicle low voltage system may comprise one or more 12V components. In some embodiments, the vehicle low voltage system may be a buffer to the auxiliary power supply.

In some embodiments, low voltage battery 106 can be connected to an internal DC-DC converter. The internal DC-DC converter may be connected to high voltage DC link 202. The internal DC-DC converter may be connected to high voltage switchgear 122 to power one or more high voltage relays.

PVIU 104 can be configured to convert an input voltage into an output voltage appropriate to a downstream use, such as to charging a high voltage battery 110. The PVIU 104 may be configured to control a charge current and/or a charge voltage for high voltage battery 110. PVIU 104 may be configured to supply electrical energy to high voltage battery junction 120. PV controller 108 may be configured to control PVIU 104, for example, by opening a circuit when no output electrical energy is to be sent to high voltage battery junction 120. The low voltage system may comprise an auxiliary battery system.

PVIU 104 may be configured to implement a Maximum Power Point Tracking (MPPT) control algorithm. The MPPT control algorithm may be configured to extract maximum available power from PV array 102.

High voltage battery junction 120 comprises PV switchgear 124. High voltage battery junction 120 can comprise battery management system (BMS) 126. High voltage battery junction 120 may comprise high voltage switchgear 122. High voltage switchgear 122 may comprise a pre-charge circuit. Junction 120 may be configured to receive electrical energy from PVIU 104 through one or more high voltage connectors. Junction 120 may be configured to send and/or receive electrical energy to high voltage battery 110.

PV switchgear 124 can comprise one or more relays, contactors, or switches. In some embodiments, PV switchgear 124 may comprise a fuse. BMS 126 can be configured to cause PV switchgear 124 to open and close. For example, BMS 126 can be configured to cause PV switchgear 124 to open or close one or more relays, contactors, or switches. As another example, BMS 126 can be configured to cause PV switchgear 124 to reduce or eliminate power provided from PV array 102 to high voltage battery 110. In some embodiments, BMS 126 may be configured to send signals to PVIU 104 to reduce or eliminate power provided from PV array 102 to high voltage battery 110. In some embodiments, BMW 126 may be configured to cause one or more shutoff systems to reduce or eliminate power provided from PV array 102 to high voltage battery 110.

Junction 120 can comprise a junction enclosure that contains one or more components discussed above (e.g., BMS 126, high voltage switchgear 122, PV switchgear 124). The junction enclosure may be configured to isolate electrical energy inside the junction enclosure. For example, the junction enclosure may be insulated. The junction enclosure may contain one or more high voltage components. The junction enclosure may be configured to enclose co-located high voltage components to contain electrical energy. In some embodiments, junction 120 can be divided into multiple sub-enclosures that each may contain one or more components. In some embodiments, junction 120 may comprise a number of electrically or mechanically attached sub-enclosures.

High voltage battery 110 may be configured to supply electrical energy to the high voltage switchgear and pre-charge circuit. The high voltage switchgear 122 may be configured to supply electrical energy to load 112.

In some embodiments, the one or more electrical motors may be configured to turn one or more wheels of a vehicle to operate the vehicle. In some embodiments, PV array 102 may be on an exterior surface of a vehicle. In some embodiments, PV array 102 may comprise a portion of a roof of a vehicle. Alternatively, PV array may be disposed within an enclosure on the vehicle that is adapted to open to allow sunlight to reach the array.

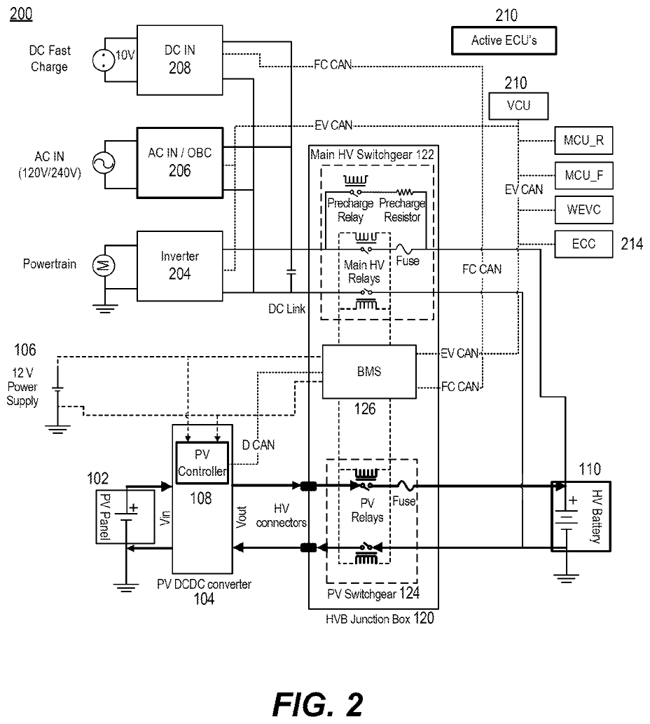

FIG. 2 is a schematic diagram of an exemplary embodiment of a first operating mode of a charging system 200. The first operating mode includes a mode of charging a high voltage battery from a PV array through a PV switchgear. Certain features of charging system 200 of the present disclosure may be similar to those of exemplary charging system 100 discussed with respect to FIG. 1. The following description of charging system 200 describes certain features of charging system 200 that may vary from those of charging system 100.

Charging system 200 can comprise DC link 202. Charging system 200 may comprise vehicle control unit (VCU) 210. Charging system 200 may comprise one or more electronic control units (ECUs) 212. Main high voltage switchgear 122 may be configured to be connected to one or more of inverter 204, AC charger 206, and/or DC charger 208. Inverter 204 may be associated with one or more electrical motors, for example, of a powertrain. BMS 126 may be configured to manage and operate high voltage switchgear 122 including whether to receive or provide electrical energy from one or more downstream devices such as inverter 204, AC charger 206, and/or DC charger 208. BMS 126 may send to and receive information from VCU 210 and/or one or more electronic control units ECUs 212. VCU 210 may be configured to control and coordinate a number of subsystems of the vehicle. One or more of the ECUs 212 may be configured to control one or more motors, sensors, and/or actuators.

Charging system 200 can have a number of operating modes. In a first operating mode, PV charging is allowed while the system is only being provided electrical energy from PV array 102. For a vehicle, the first operating mode may occur when the vehicle is parked or in an off mode. During the PV array 102 charging mode, BMS 126 and PVIU 104 may operate to provide electrical energy from PV array 102 to the high voltage battery 110, e.g., to charge the high voltage battery 110.

As shown in FIG. 2, the PV array 102 may provide energy to high voltage battery 110 consistent with the lines shown with arrows and labeled 250 and 251 for the supply and return respectively. This may occur when one or more ECUs are in a sleep state.

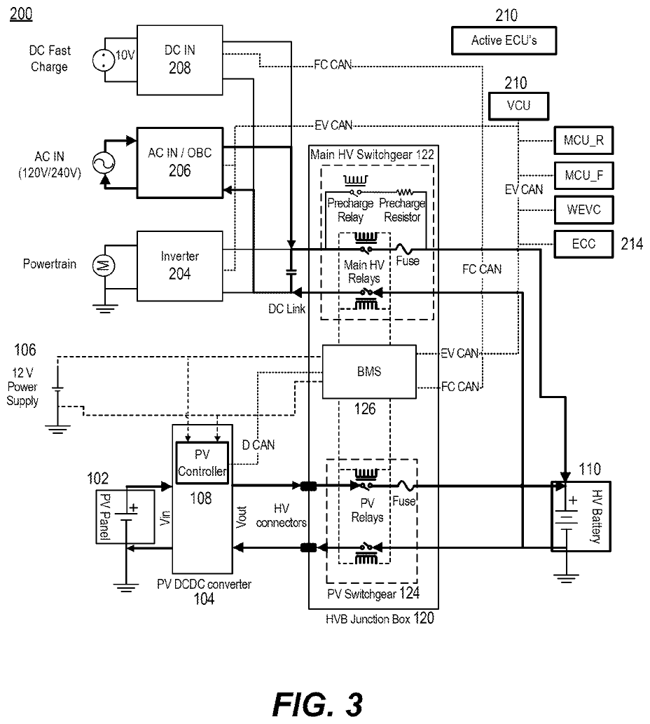

FIG. 3 shows an exemplary embodiment of an operating mode of charging system 200. Certain features of charging system 200 may be similar to those of exemplary charging system 100 discussed with respect to FIG. 1. The following description of charging system 200 describes certain features of charging system 200 that may vary from those of charging system 100.

Charging system 200 can operate in an AC charging operating mode. The AC charging operating mode can allow AC Charging and PV charging at least substantially simultaneously. AC charging operating mode can be used when the vehicle is parked or in an off mode and is plugged into an AC-main supply. During the AC charging operating mode, vehicle is plugged into an AC-main supply and an on-board charging (OBC) system charges high voltage battery 110. During this second operating mode, OBC communicates to VCU 210 over EV CAN, and one or more ECU's on EV CAN can be active. PV array 102 and PVIU 104 may be active and can charge the high voltage battery at least substantially simultaneously with OBC.

As shown in FIG. 3, the PV array 102 can provide energy to high voltage battery 110 consistent with the lines shown with arrows and labeled 252 and 253 for the supply and return respectively. At least substantially simultaneously, as also shown with arrows and labeled 252 and 253 for the supply and return respectively, the high voltage battery 110 can receive energy through DC link 202 and main high voltage switchgear 122 from the AC charger 206.

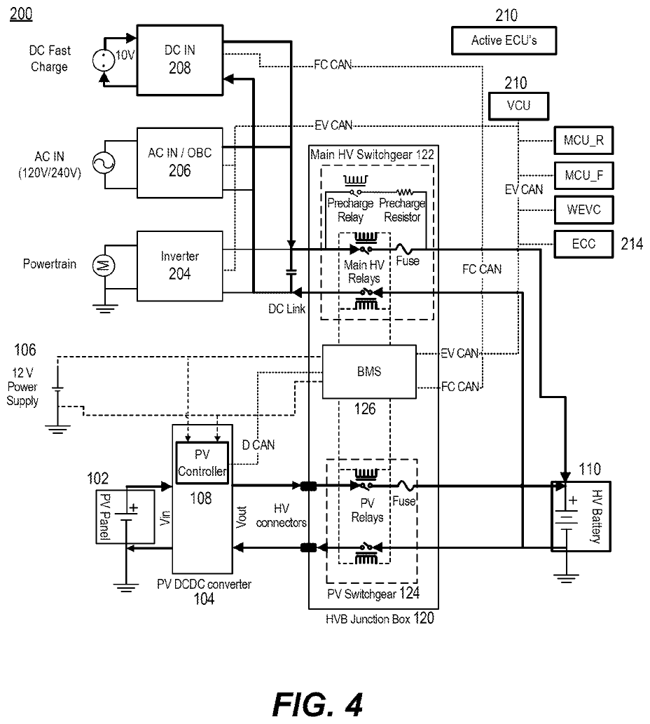

FIG. 4 shows an exemplary embodiment of another operating mode of charging system 200. Certain features of charging system 200 may be similar to those of exemplary charging system 100 discussed with respect to FIG. 1. The following description of charging system 200 describes certain features of charging system 200 that may vary from those of charging system 100.

Charging system 200 can operate in a DC charging operating mode. A third operating mode allows DC Charging and PV charging at least substantially simultaneously. This third operating mode can be employed when the vehicle is parked or in an off mode and is plugged into a DC-main supply. During this operation, the vehicle may be plugged into a DC charger 208 configured to directly charge high voltage battery 110. During this operation, VCU 210 monitors the charging process. As a result, one or more ECU's 212 on EV CAN may be active because VCU 210 is active and operating CAN. Energy Control Center (ECC) 214 operation for thermal controls may be active because ECC 214 may be used during a charge process associated with DC charger 208. The PVIU 104 may also operate to charge the vehicle at least substantially simultaneously with DC charger 208.

As shown in FIG. 4, the PV array 102 can provide energy to high voltage battery 110 consistent with the lines shown with arrows and labeled 254 and 255 for the supply and return respectively. At least substantially simultaneously, as also shown with arrows and labeled 254 and 255 for the supply and return respectively, the high voltage battery 110 may receive energy through DC link 202 and main high voltage switchgear 122 from DC charger 208.

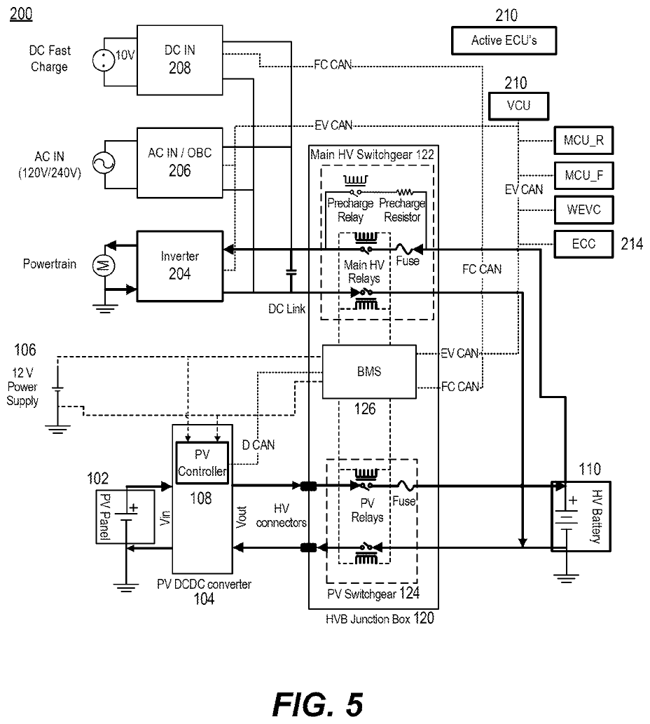

FIG. 5 is a schematic diagram depicting a fourth operating mode of charging system 200. Certain features of charging system 200 may be similar to those of exemplary charging system 100 discussed with respect to FIG. 1. The following description of charging system 200 describes certain features of charging system 200 that may vary from those of charging system 100.

Charging system 200 can operate in a drive mode where PV charging is enabled. The PV charging operational mode may be used when the vehicle is supplying energy from a high voltage battery (e.g., high voltage battery 110) to an electro-mechanical system (e.g., an electric motor associated with a powertrain). During drive mode, one or more ECUs cab be active, and the one or more ECUs are configured to manage different functions of the vehicle. In this operational mode, high voltage battery 110 can be configured to supply power to the powertrain. In this operational mode, high voltage battery 110 can be configured to receive power from the powertrain during regenerative braking. A PV system including a PV array can operate at least substantially simultaneously to provide charge to high voltage battery 110 while high voltage battery 110 is sending or receiving power.

As shown in FIG. 5, the PV array 102 may provide energy to High Voltage battery 110 consistent with the lines shown with arrows and labeled 256 and 257 for the supply and return respectively. At least substantially simultaneously, as also shown with arrows and labeled 256 and 257 for the supply and return respectively, the high voltage battery 110 may provide energy through DC link 202 and main high voltage switchgear 122 to inverter 204 and to the powertrain.

FIG. 6 shows a diagram of a communication system consistent with the present disclosure. Some aspects of the communication system may be shown in FIGS. 1-5. The communication system can include PVIU 600, BMS 602, gateway 604, T-Box 606, cloud 608, UI/UX controller 610, and display 612. PVIU 600 may communicate with BMS 602 through D CAN. BMS 602 may communicate with gateway 604 through EV CAN. BMS 602 may communicate with UI/UX controller. Gateway 604 may receive communication from BMS 602 and may output communication to T-Box 606. Gateway 604 may communication with T-Box 606 through T CAN, which may include a flexible data rate. T-Box may be configured to upload information to cloud 608. UI/UX controller 610 may be configured to communicate with cloud 608.

The uploaded information may comprise one or more of: instantaneous energy generated by PV array; energy generated by PV array over a period of time (e.g., an hour, a day, a month, a year); and total energy generated. The information may be generated by BMS 602 and/or PVIU 600 consistent with the present disclosure. UI/UX controller can be configured to communicate with a vehicle display 612 to display information, such as expected range of a vehicle, available power, time to charge or other information computed by the BMS and/or the UI/UX controller consistent with the present disclosure.

FIG. 7 is a flow chart depicting an exemplary method 700 of computing power available from a PV array. Method 700 can include step 701 that includes the PVIU beginning in a sleep state. Method 700 can include step 702 that includes determining that an input voltage to the PVIU is greater than a predetermined voltage. In some embodiments, the predetermined voltage may be 9V. It is to be understood that 9V is exemplary. The predetermined voltage may be based on a low-voltage system. If step 702 determines the input voltage is less than a predetermined voltage, the PVIU may return to a sleep step 701. If step 702 determines the input voltage is greater than a predetermined voltage, then method 700 may proceed to step 704.

Step 704 can include a wake up or power up step. Step 704 can include a step of providing power to a processor of a PVIU. Method 700 may proceed to step 706 that includes closing a switch. The switch may be associated with a transformer. The switch may be associated with a load (e.g., to a high voltage battery). Method 700 may then proceed to step 708. Step 708 may include a determination of whether the available input power is greater than a threshold input power. In some embodiments, the threshold input power may be 30 W. In some embodiments, the threshold input power may be based on an expected input power amount based on at least one of the time of day, an area of the PV array, a location of a vehicle, an orientation of a vehicle, and an angle of the PV array. If step 708 determined that available input power is less than the threshold input power, method 700 may proceed to step 710. Step 710 can include entering a timeout of a predetermined time period. The predetermined time period may be configurable. The predetermined time period may be 5-15 minutes. In some embodiments, the predetermined time period may be based on data particular to one or more of a time of day, a time of year, a location of a vehicle, a schedule, a time-table, or a weather determination. After a timeout in step 710, method 700 may proceed to step 701 to restart a wake-up method 700.

If step 708 determines that the available input power is greater than a threshold input power, method 700 may proceed to step 712. Step 712 may include a step of sending a wake-up signal to a BMS. Method 700 may then end in step 714.

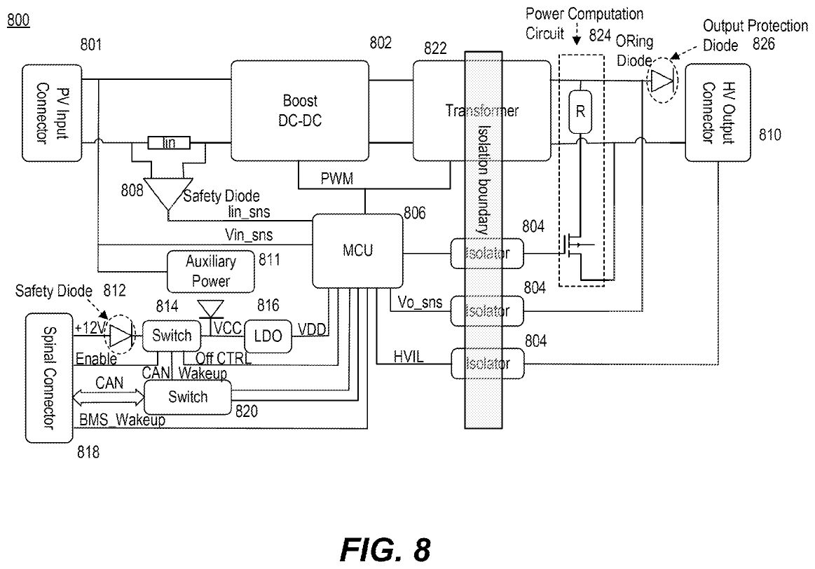

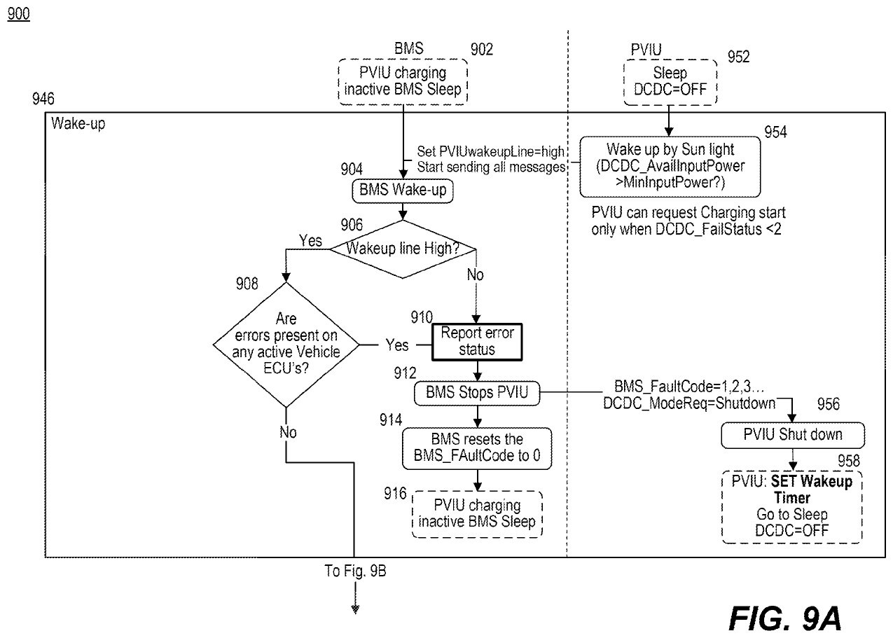

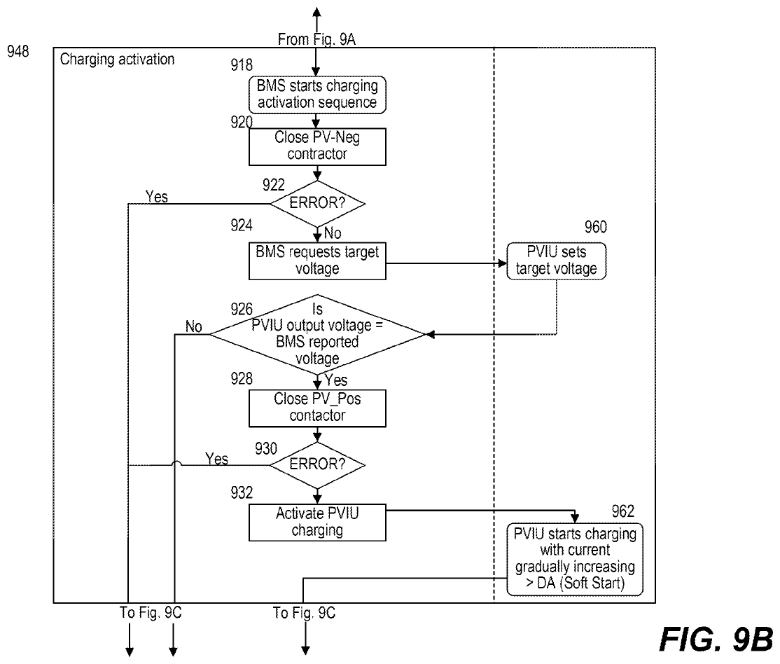

FIG. 8A is a schematic diagram depicting an exemplary embodiment of a PVIU 800. The PVIU 800 may be a PV DC-DC converter consistent with one or more of the other disclosed embodiments (e.g., PVIU 104). The PVIU may be configured to implement current control and/or mitigate any transients and/or spikes.

PVIU 800 may include a PV input connector 801 that connects the PVIU to the PV array (e.g., PV array 102). PVIU 800 may be configured to allow energy to flow from the PV array through the PVIU. PVIU may include boost DC-DC module 802. Boost DC-DC module 802 may include a converter configured to convert a first DC voltage input to a second DC voltage output. Second DC voltage output may be used by a high voltage system, such as to provide energy to a high voltage battery. Second DC voltage output may be provided through high voltage output connector 810 to a high voltage battery (e.g., high voltage battery 110). For example, high voltage output connector 810 may be connected to a photovoltaic switchgear (e.g., PV switchgear 124) that connects to the high voltage battery.

PVIU 800 may include transformer 822. Transformer 822 can be configured to transfer energy from one circuit (e.g., associated with a PV array) to another circuit (e.g., associated with a high voltage battery). PVIU 800 may include power computation circuit 824. Power computation circuit 824 may be configured to compute power produced by the PV array. Power computation circuit 824 may be configured to compute an energy transformed by transformer 822. Power computation circuit 824 may include a pulse module that measures a pulse provided by the PV array to compute the available power from the PV array. Power computation circuit 824 may include a series resistor and/or a MOSFET.

PVIU 800 may include output protection diode 826. Output protection diode 826 may be configured to block voltages if the high voltage system, including the high voltage battery, experiences a short circuit that exposes the PVIU to an AC or a DC charger input. The voltage blocked by the output protection diode 826 may be a transient voltage. Output protection diode 826 can be configured to block a voltage if a fuse in the high voltage battery system fails. Output protection diode 826 can be configured to reduce or eliminate transients or noise in the photovoltaic integration unit from high voltage connection through high voltage output connector 810.

PVIU 800 may include control unit safety diode 808 and PVIU safety diode 812. Control unit safety diode 808 may protect control unit (MCU) 806 from a voltage of photovoltaic array through PV input connector 801. PVIU safety diode 812 may be configured, in the case of a failure, to prevent energy feedback from the PV array and/or the high voltage battery to the 12V battery. PVIU safety diode 812 may be configured to prevent circulating currents within the high voltage system and the PV system. For example, circulating currents may occur in the case of a fault condition. In some embodiments, PVIU safety diode 812 may allow the 12V battery input and the PV array input to share a ground.

PVIU 800 may be insulated from electromagnetic interference (EMI) from other load components connected to the DC link. Transformer 822 and isolators 804 may be configured to insulate the PV system. PVIU 800 may use a line diode to prevent exposure to ripple content or energy feedback from the high voltage switchgear and/or other high voltage or low voltage components.

PVIU 800 may include control unit 806. PVIU 800 may include auxiliary power module 811. Auxiliary power module 811 can include a 12V system. Auxiliary power module 811 can include a connection to a 12V system shared with one or more other systems (e.g., low voltage battery 106). Auxiliary power module 811 may be configured to provide power to control unit 806. Auxiliary power module 811 may be connected to switch 814 and low dropout regulator 816. Switch 814 may be connected to safety diode 812 that separates switch 814 and signal connector 818. Signal connector 818 and/or switch 814 may be connected to transceiver 820. Signal connector 818 may send and/or receive signals from control unit 806. Transceiver 820 may send and/or receive signals from control unit 806. Control unit 806 may be connected to power computation circuit 824 through an isolator 804. Control unit 806 may be connected to output protection diode 826 through an isolator 804. Control unit 806 may be connected to high voltage output connector 810 through an isolator 804.

FIG. 8B is a schematic diagram depicting an exemplary embodiment of a PVIU 830. PVIU 830 may be similar to PVIU 800 as discussed above with reference to FIG. 8A except as otherwise discussed below. PVIU 830 may include power computation circuit 832 on a low voltage side of a circuit. The low voltage side of the circuit may be isolated from the high voltage output connector. The isolation boundary forming the isolation may comprise one or more isolators and/or a transformer. The transformer may include or be compartmentalized with a converter. The converter may be a second-stage converter.

FIG. 8C is a schematic diagram depicting an exemplary embodiment of a PVIU 860. PVIU 860 may be similar to PVIU 800 as discussed above with reference to FIG. 8A except as otherwise discussed below. PVIU 860 may include power computation circuit 862 on a high voltage side of a circuit. The power computation circuit may be configured as shown with reference to FIG. 8A, with a resistor on an output protection diode side of a transistor, or as configured as shown in FIG. 8C, with a resistor on an output protection diode side of a transistor.

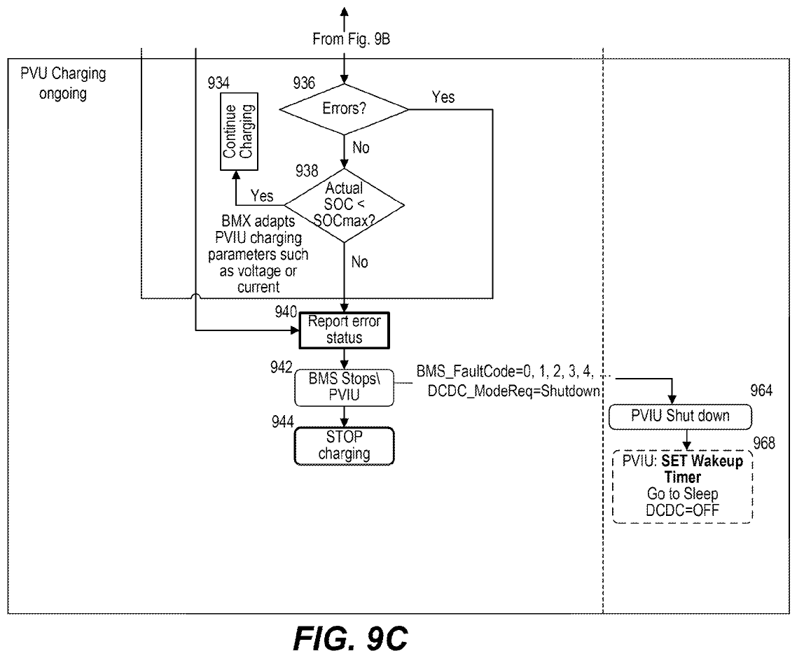

FIGS. 9A-9C is a flow chart of an exemplary method of operating a converter and a battery management system. The method of operating a converter and a battery management system 900 can include wake up/power up method 946, charging activation method 948, and PVIU ongoing charging method 950. A PVIU (e.g., PVIU 104) and a BMS (e.g., BMS 126) may operate to perform one or more steps of wake up/power up method 946, charging activation method 948, and/or PVIU ongoing charging method 950. Methods 946, 948, and 950 may be operated in a series as shown in FIG. 6 or any portion or steps of methods 946, 948, and/or 950 may be operated separate from other steps. As shown in FIGS. 9A-9C, some portions of methods 946, 948, and 950 may be operated by a BMS (e.g., BMS 126) and some may be operated by a PVIU (e.g., PVIU 104).

Step 902 may include a step in which BMS (e.g., BMS 126) in an off mode or a sleep mode and is drawing no charge or a reduced charge from an auxiliary battery system (e.g., low voltage battery 106). Step 952 may include a step where a PVIU (e.g., PVIU 104) is in an off mode or a sleep mode and is drawing no charge or a reduced charge from an auxiliary battery system (e.g., low voltage battery 106).

Step 954 may include a step where the PVIU is powered on (e.g., is in a wake-up mode). In some embodiments, a portion of PVIU being powered and operational may be associated with a wake-up mode. The PVIU may be powered on when it receives power from a photovoltaic array (e.g., photovoltaic array 102). This may occur, for example, when the photovoltaic array receives power from the sun or when the available input power is greater than a threshold minimum input power. The threshold minimum input power may be determined based on a draw power required by the PVIU and/or the BMS. The threshold minimum input power may be determined based on a minimum power required by a high voltage battery. The PVIU may be powered on based on a time of day.

In some embodiments, the PVIU may send a message to the BMS requesting a start to charging the high voltage battery (e.g., high voltage battery 110) from the photovoltaic array. For example, this PVIU may send the message to the BMS requesting a start to charging when the PVIU status is optimal and/or when the PVIU is not receiving a fault signal. In some embodiments, the PVIU may send another message to the BMS with a PVIU wake-up line that reflects an available power from the PVIU.

Step 904 may include the BMS receiving a signal from the PVIU to wake up/power up. Step 904 may include where the BMS is in a wake-up mode. The BMS may enter a wake-up mode to determine whether the high voltage battery (e.g., high voltage battery 110) will receive power from the photovoltaic array. The wake-up mode may include at least partial functionality for the BMS to conduct one or more steps of methods 946, 948, and 950. In some embodiments, a portion of BMS being powered and operational may be associated with a wake-up mode. The BMW may be configured to receive messages from the PVIU including the message from the PVIU requesting to start providing power.

Step 906 may include BMS determining whether the PVIU wake-up line is high or not, based on one or more received messages from the PVIU. If the wake-up line is high, the BMS may progress to step 908 where the BMS determines whether one or more errors are present on any active vehicle ECUs. The wake-up line may be high, for example, when the power available from the PVIU does not meet or exceed a threshold amount of power required by the high voltage battery. If the wake-up line is not high, the BMS can progress to step 910 that may include a step where the BMS reports an error status. If the BMS determines errors are present in step 908, the BMS may report an error status in step 910.

After reporting an error status in step 910 and/or determining that photovoltaic charging should not occur, the BMS may progress to step 912 in which BMS sends a stop signal to the PVIU. BMS may generate a fault code associated with the error that is sent to PVIU alone or with the stop signal. BMS may then progress to step 914 that resets a fault code to zero or an amount or symbol that reflects a reset state. BMS may then progress to step 916 where the BMS returns to a powered off or reduced power mode (e.g., a sleep mode). In step 916, charging through the PVIU may be inactive.

After the BMS sends the stop signal to the PVIU, the PVIU may proceed to step 956 where the PVIU orders a shut down. The PVIU may then proceed to step 958 where the PVIU sets a wake-up timer that may be configured to wake up/power up the PVIU after a time. The PVIU may then return to a powered off or reduced power mode (e.g., a sleep mode) while the timer counts until the wake-up time or until an event, such as vehicle start-up, occurs.

If no errors are present in step 908, and if the wake-up line is determined to be high in step 906, the BMS may proceed to method 948, illustrated in FIG. 9B, reflecting charging activation. The BMS may begin method 948 by step 918 that may include starting a charging activation sequence. The BMS may then proceed to step 920 where the BMS operates a photovoltaic switchgear (e.g., PV switchgear 124) to close the contactor and allow charge to flow from the photovoltaic array to the high voltage battery.

Once a command has been given for the photovoltaic switchgear to close in step 920, the BMS may determine whether an error exists in the system in step 922. The error in step 922 may refer to a ground fault, a failure of the photovoltaic switchgear to close, a processor failure, a lack of power to the BMS, or a number of other failures in the vehicle. If the error exists, the BMS may proceed to step 940 of method 950.

If no error is found, or if a threshold of errors is not met, in step 922, the BMS may proceed to step 924 that may include the BMS sending a message to the PVIU requesting a target voltage. Once the BMS requests the target voltage in step 924, the PVIU may determine the target voltage in step 960. The PVIU may set the target output voltage in step 960 based on a calculated available power from the photovoltaic array. The PVIU may set the target output voltage in step 960 based on an estimated available power from the photovoltaic array that may be based on a time of day. The PVIU may then send the target output voltage to the BMS.

After step 960, the BMS may receive the message including the target output voltage from the PVIU. The BMS may proceed to step 926 where the BMS may compare the PVIU target output voltage to the BMS reported voltage reflecting a voltage of the high voltage battery. If the PVIU voltage meets or exceeds the voltage of the high voltage battery, the BMS may proceed to step 928. If the PVIU voltage does not meet or exceed the voltage of the high voltage battery, the BMS may proceed to step 940 of method 950.

Step 928 may be similar to step 920 where the BMS operates a photovoltaic switchgear (e.g., PV switchgear 124) to close and allow charge to flow from the photovoltaic array to the high voltage battery. Once a command has been given for the photovoltaic switchgear to close in step 928, the BMS may determine whether an error exists in the system in step 930, similar to step 922. The error in step 930 can refer to a ground fault, a failure of the photovoltaic switchgear to close, a processor failure, a lack of power to the BMS, or a number of other failures in the vehicle. If the error exists, the BMS may proceed to step 940 of method 950, illustrated in FIG. 9C.

Although step 940 is shown in method 950, step 940 can be performed at any time, such as with a result where the BMS determines to discontinue charging such as from steps 922, 926, and 930.

If no error exists in step 930, the BMS may proceed to step 932 to activate PVIU charging. Step 932 can include a step of activating PVIU charging and may include sending a message to the PVIU to activate charging.

Once the message to the PVIU to activate charging is received by the PVIU, the PVIU may proceed with step 962 that includes a step of gradually increasing current from the photovoltaic array from a relatively low level such as zero amps. Gradually increasing current may be known as a soft start.

Once step 962 has completed or at least started, the PVIU can report to the BMS that charging has begun and the BMS may proceed to method 950 of ongoing charging.

Method 950 of ongoing charging may include the BMS proceeding to step 936 where the BMS determines whether any errors exist, such as those errors discussed above. If an error exists, the BMS may proceed to step 940.

If no error is determined in step 936, the BMS can proceed to step 938 that may include a step of the BMS determining whether an actual state of charge is less than a threshold state of charge. The threshold state of charge may be a maximum state of charge. The threshold state of charge may be a state of charge such that the high voltage battery cannot accept further charge from the photovoltaic array. The threshold state of charge may be a state of charge that is optimal for vehicle operation. If the actual state of charge is less than the threshold state of charge, then the BMS may proceed from step 938 to step 934, where step 934 may include a step where the BMS determines to continue charging from the photovoltaic array to the high voltage battery. In step 934, the BMS may adapt a charging parameter such as voltage and/or current output to meet a desired output (e.g., to charge a high voltage battery). After step 934 may continue to step 934 where the BMS proceeds to continue to step 936 where the BMS determines whether any errors exist. The BMS may loop such that it continues through steps 936, 938, and 934 to determine whether to continue to charge the high voltage battery from the photovoltaic array. The BMS may loop such that it continues to determine in step 934 to charge at a desired output voltage and/or current.

If the BMS determines the actual state of charge is greater than the threshold state of charge in step 938, the BMS may proceed to step 940.

In step 940, the BMS can report an error or the result from step 926 or step 938 where the BMS may determine that charging from the photovoltaic array should stop. After step 940, the BMS can proceed to step 942 where the BMS sends a stop message to the PVIU to stop charging. After reporting an error status in step 940 and/or determining that photovoltaic charging should not occur, the BMS can progress to step 942 where the BMS sends a stop signal to the PVIU. The BMS may generate a fault code to send to the PVIU alone or with the stop signal. The BMW may then progress to step 944 where the BMS returns to a powered off or reduced power mode (e.g., a sleep mode).

After the BMS sends the stop signal to the PVIU, the PVIU can proceed to step 964 where the PVIU orders a shut down. Step 964 can include opening the photovoltaic switchgear (e.g., photovoltaic switchgear 124). The PVIU can then proceed to step 968 where the PVIU sets a wake-up timer that may be configured to wake-up the PVIU after a time consistent with the wake-up timer discussed above. The PVIU may then return to a powered off or reduced power mode (e.g., a sleep mode).

As discussed above, with reference to FIG. 1, a high voltage switchgear (e.g., high voltage switchgear 122) may be operated by the BMS, but the high voltage switchgear may not be powered during one or more of the methods of 946, 948, 950. As also discussed above, one or more electronic control units (e.g., ECUs 212) may not be powered during one or more of the methods of 946, 948, 950. As also discussed above, the BMS may operate so that the high voltage battery may receive power from the high voltage switchgear during one or more of the methods of 946, 948, 950.

It is understood that while certain embodiments are discussed to facilitate understanding of various principles and aspects of this disclosure, the embodiments are not described in isolation and the descriptions are not necessarily mutually exclusive. Thus, it is contemplated and understood that described features of principles of any embodiment may be incorporated into their embodiments.

It will be apparent to those skilled in the art that various modifications and variations can be made to the disclosed battery management system, photovoltaic system, photovoltaic controller, and method for ramping. While illustrative embodiments have been described herein, the scope of the present disclosure includes any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the present disclosure. It is intended, therefore, that the specification and examples be considered as exemplary only, with a true scope and spirit of the present disclosure being indicated by the following claims and their full scope of equivalents.

What is claimed is:

1. A charging system comprising:
a first battery;
a photovoltaic array;
a junction enclosure comprising a high voltage switchgear and a photovoltaic switchgear, wherein the photovoltaic switchgear is configured to receive power from the photovoltaic array, and wherein the high voltage switchgear is configured to receive power from the first battery at the same time the first battery receives power from the photovoltaic array through the photovoltaic switchgear; and
a battery management system comprising a processor configured to cause the photovoltaic switchgear to open and close;
wherein the first battery receives power from the photovoltaic array when the photovoltaic switchgear is closed.

2. The charging system of claim 1, wherein the battery management system identifies a state of charge of the first battery, wherein if the state of charge of the first battery is less than a threshold, the battery management system allows a photovoltaic integration unit to convert a first voltage received from the photovoltaic array to a second voltage for the first battery.

3. The charging system of claim 2, wherein the second voltage for the first battery is delivered to the first battery through the photovoltaic switchgear.

4. The charging system of claim 2, wherein if the state of charge of the battery is more than a threshold, the battery management system is configured to cause a reduction or elimination of power received from the photovoltaic array.

5. The charging system of claim 1, wherein a photovoltaic integration unit comprises a transformer configured to transfer power from the photovoltaic array to the high voltage switchgear, wherein the photovoltaic integration unit comprises an output diode configured to reduce or eliminate transients or noise in the photovoltaic integration unit from a high voltage connection.

6. The charging system of claim 1, wherein the photovoltaic array is configured to supply power to the first battery when the first battery is receiving power from the high voltage switchgear.

7. The charging system of claim 1, wherein the high voltage switchgear is open when the photovoltaic switchgear is closed.

8. The charging system of claim 1, further comprising an electronic control unit configured to control operation of one or more electric motors, wherein the photovoltaic switchgear is powered by a second battery when the electronic control unit is not powered.

9. The charging system of claim 1, further comprising a photovoltaic integration unit configured to compute available power from the photovoltaic array; wherein the photovoltaic integration unit communicates the available power to the battery management system.

10. A vehicle comprising:
a high voltage battery configured to supply electrical energy to an electric motor;
a photovoltaic array;
a junction enclosure comprising a high voltage switchgear and a photovoltaic switchgear, wherein the photovoltaic switchgear is configured to receive charge from the photovoltaic array, wherein the high voltage battery supplies electrical energy to the electric motor through the high voltage switchgear;
a direct current link configured to close when energized; and
a battery management system configured to cause the photovoltaic switchgear to open and close;
wherein the high voltage battery receives power from the photovoltaic array when the photovoltaic switchgear is closed, wherein the battery receives power from the photovoltaic array when the direct current link is not energized.

11. The vehicle of claim 10, wherein the high voltage switchgear is open when the photovoltaic switchgear is closed.

12. The vehicle of claim 10, wherein the battery management system identifies a state of charge of the high voltage battery, wherein if the state of charge of the high voltage battery is less than a threshold, a photovoltaic controller converts a first voltage produced by the photovoltaic array to a second voltage for the high voltage battery.

13. The vehicle of claim 10, further comprising an electronic control unit configured to control operation of an electric motor, wherein the photovoltaic switchgear is powered by a low voltage battery when the electronic control unit is not powered.

14. The vehicle of claim 10, wherein the battery management system identifies a state of charge of the high voltage battery, wherein if the state of charge of the high voltage battery is more than a threshold, the battery management system is configured to cause a reduction or elimination of power received from the photovoltaic array.

15. A vehicle comprising:
a high voltage battery;
a photovoltaic array;
a photovoltaic switchgear configured to supply power from the photovoltaic array to the high voltage battery when the high voltage battery receives power from a charger through a high voltage switchgear, and wherein the photovoltaic switchgear is powered by a low voltage battery;
a battery management system configured to operate circuitry associated with the battery to allow the high voltage battery to receive and provide power, wherein the battery management system is configured to monitor a state of charge of the high voltage battery; and
a photovoltaic integration unit configured to send a signal to the battery management system to enter a wake up mode, wherein in the wake up mode the battery management system determines whether to receive power from the photovoltaic array based on the state of charge of the high voltage battery.

16. The vehicle of claim 15, wherein if a state of charge of the high voltage battery is more than a threshold, the battery management system is configured to open the photovoltaic switchgear so that the high voltage battery does not receive power from the photovoltaic array.

17. The vehicle of claim 15, further comprising a high voltage switchgear is open when the photovoltaic array supplies power to the high voltage battery.

18. The vehicle of claim 15, further comprising an electronic control unit configured to control operation of an electric motor, wherein the photovoltaic switchgear is powered by a second battery when the electronic control unit is not powered.

19. The vehicle of claim 15, wherein the photovoltaic integration unit is configured to compute available power from the photovoltaic array.

20. The vehicle of claim 15, wherein the photovoltaic integration unit comprises a transformer configured to transfer power from the photovoltaic array to the photovoltaic switchgear, wherein the photovoltaic integration unit comprises an output diode configured to reduce or eliminate transients or noise in the photovoltaic integration unit from a high voltage connection.
